(19) United States
(12) Patent Application Publication
(10) Pub. No.: US 2007/0120642 A1
(43) Pub. Date: May 31, 2007

(54) Vehicle with passive key fob having presence detection arrangement with key fob

(75) Inventors: Karthikeyan R. Narayanaswamy, Canton, MI (US); John R. Costello, Rochester Hills, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/433,004

(22) Filed: May 12, 2006

Related U.S. Application Data
(60) Provisional application No. 60/740,069, filed on Nov. 28, 2005.

(51) Int. Cl. G05B 19/00

(52) U.S. Cl. 340/5.61; 340/5.72

(57) ABSTRACT

A passive key fob reader for receiving a key fob and controlling actuation of a vehicle is provided with a “wake up” system that includes a sensor, such as a reed or Hall-effect switch which can sense the presence of a magnet on the key fob. The key fob is preferably provided with a magnet such that when inserted into the key fob reader, it wakes up the sensor, and causes the sensor to actuate a control to query the key fob and identify whether the key fob has an appropriate identification number. In a second embodiment, the sensor is located remotely from the key fob reader.

### RELATED APPLICATIONS

The application claims priority to U.S. Provisional Application No. 60/740,069 which was filed on Nov. 28, 2005.

### BACKGROUND OF THE INVENTION

Modern vehicles are being provided with key fobs that allow electronic access to the vehicle. One type of key fob is a so-called passive key fob, wherein the key fob is solely an electronic item. The key fob is inserted into a reader. The reader looks for an identifying code on the key fob, and if an appropriate code is found, it allows actuation of the vehicle such as through an ignition switch.

In the prior art, insertion of some device other than a key fob into a key fob reader will wake the circuit, and cause the circuit to query the device in the reader. A mechanical switch and contact mechanism has been utilized. These mechanical switches and contact mechanisms have been subject to failure after repeated wear. Further, tolerance stack-ups of all the various mechanical components have to be considered, and closely controlled to ensure switch contact as a key fob is inserted into the reader.

The required mechanical switches have been tailored for each individual system, which is undesirably expensive. Moreover, the required mechanical switches are relatively large in size, and require space that puts constraints on the possible locations for the reader.

### SUMMARY OF THE INVENTION

In a disclosed embodiment of this invention, the presence of a key fob in a key fob reader will be determined electronically. In this manner, the mechanical switches required in the prior art are eliminated. Further, the false readings when an item other than a key fob has been inserted will also be eliminated. In a disclosed embodiment of this invention, the key fob is provided with a magnetic member. The magnetic member is sensed by a sensor such as a reed or Hall-effect sensor within the key fob reader. This sensor may be relatively small, and the elimination of the mechanical contact results in the sensor having a relatively long life compared to the prior art. Further, there is little or no deterioration of the sensor, and the detection and accuracy over the life of the product.

These and other features of the present invention can be best understood from the following specification and drawings, the following of which is a brief description.

### BRIEF DESCRIPTION OF THE DRAWINGS

FIG. 1 is a schematic view of a first embodiment.

FIG. 2 is a schematic view of a second embodiment.

### DETAILED DESCRIPTION OF THE PREFERRED EMBODIMENT

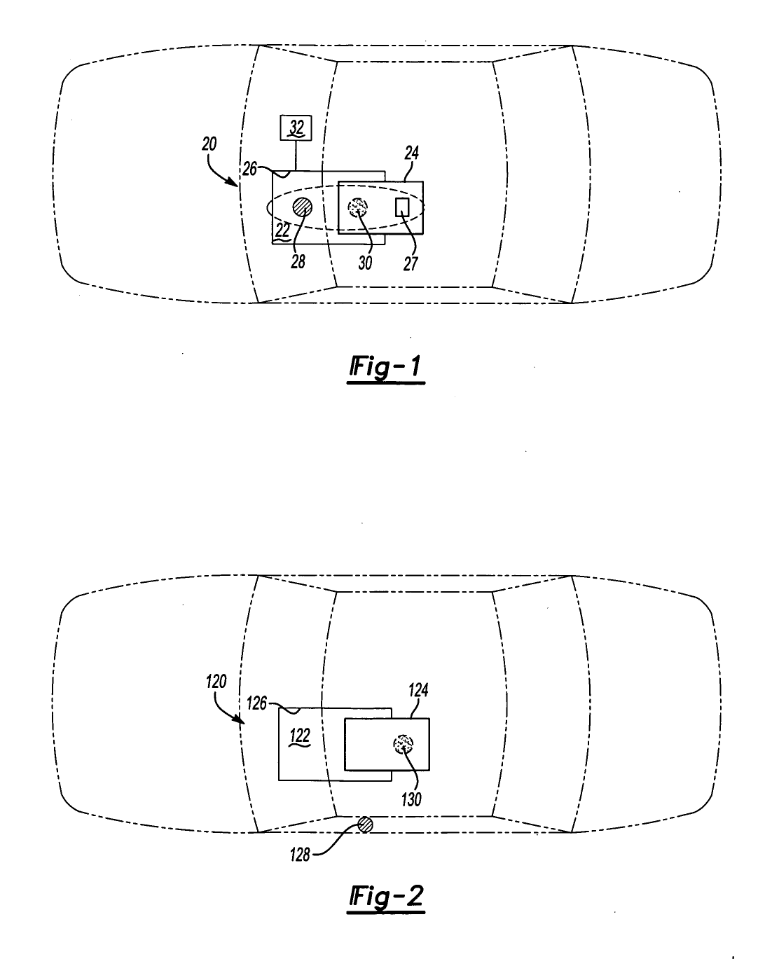

A first embodiment 20 is illustrated in FIG. 1, having a key fob reader 22 which receives a key fob 24. As known, a printed circuit board 26 includes the electronics to query the key fob 24 and actuate a transmitter 27 which transits a code to be read by the printed circuit board 26. If this code is as expected by the printed circuit board 26 and the associated control, then the key fob is authorized. At that point, an ignition switch 32 may be actuated to start the ignition of the car.

The present invention improves upon the prior art by including a magnet 30 on a key fob 24. The presence of the magnet 30 is sensed by a sensor 28. Sensor 28 may be a reed switch or Hall-effect switch which can sense the presence of the magnet 30. In the prior art, a magnetic contact was made when the key fob 24 was inserted. The present invention allows a sensing range as shown by dotted line in FIG. 1, which will allow a reduction in the required space for the key fob reader 22. Moreover, the elimination of the mechanical switches provides benefits as mentioned above.

The size of the key fob reader 22 and the key fob 24 are shown greatly exaggerated relative to the size of the vehicle. However, this is done for simplicity of understanding the illustration.

FIG. 2 shows a second embodiment 120. In the second embodiment 120, the key fob 124 is received in a reader 122 having a printed circuit board 126 as in the first embodiment. However, the sensor 128 is located remotely, and can sense the presence of an appropriate key fob 124 when the key fob first enters the vehicle.

Although preferred embodiments of this invention have been disclosed, a worker of ordinary skill in this art would recognize that certain modifications would come within the scope of this invention. For that reason, the following claims should be studied to determine the true scope and content of this invention.

What is claimed is:

1. A security system for a vehicle comprising:
a key fob reader for receiving a key fob, and including a control for querying the key fob receiving a signal indicative of a code from the key fob, and comparing said received code to an expected code to authorize actuation of the vehicle when a key fob is inserted in the key fob reader;
a key fob receiving a magnetic member and carrying an identifying code and a transmitter; and
a sensor for sensing the presence of the magnetic member on a key fob, said sensor waking up the key fob reader to query the key fob when a magnetic member is sensed.

2. The security system as set forth in claim 1, wherein a printed circuit board is received within said key fob reader and includes said control.

3. The security system as set forth in claim 2, wherein said sensor is associated with said printed circuit board in said key fob reader.

4. The security system as set forth in claim 2, wherein said sensor is associated with said key fob reader.

5. The security system as set forth in claim 1, wherein said sensor is located remotely from said key fob reader.

6. The security system as set forth in claim 1, wherein said sensor is a reed switch.

7. The security system as set forth in claim 1, wherein said sensor is a Hall-effect sensor.

8. A method of operating a security system for a vehicle including:
providing a key fob reader for receiving a key fob, and including a control, said control querying the key fob, receiving a signal indicative of a code from the key fob, and comparing said received code to an expected code to authorize actuation of the vehicle, when a key fob is inserted in the key fob reader;
providing a key fob having a magnetic member and carrying an identification code; and
sensing the presence of a magnetic member on a key fob, and waking up the key fob reader to query the key fob when a magnetic sensor is sensed.

9. The method as set forth in claim 8, wherein a printed circuit board is received within said key fob reader and includes said control.

10. The method as set forth in claim 8, wherein said sensor is associated with said printed circuit board in said key fob reader.

11. The method as set forth in claim 8, wherein said sensor is associated with said key fob reader.

12. The method as set forth in claim 8, wherein said sensor is located remotely from said key fob reader.

13. The method as set forth in claim 8, wherein a reed switch senses the magnetic member.

14. The method as set forth in claim 8, wherein a Hall-effect sensor senses the magnetic member.
